(19) United States
(12) Patent Application Publication
(10) Pub. No.: US 2009/0034296 A1
(43) Pub. Date: Feb. 5, 2009

(54) Light Emitting Unit, Illumination Device Using Such Light Emitting Unit, and Image Scanner

(75) Inventors: Tomihisa Saito, Tokyo (JP); Hiroyuki Nemoto, Tokyo (JP); Hidemitsu Takeuchi, Tokyo (JP); Takashi Kishimoto, Tokyo (JP); Naofumi Sumitani, Tokushima (JP)

Correspondence Address: CARRIER BLACKMAN AND ASSOCIATES, 24101 NOVI ROAD, SUITE 100, NOVI, MI, 48375, US

(73) Assignees: Nippon Sheet Glass Co., Limited, Minato-ku, Tokyo (JP); Nichia Corporation, Anan-shi, Tokushima (JP)

(21) Appl. No.: 11/887,877

(22) PCT Filed: Apr. 3, 2006
(86) PCT No.: PCT/JP2006/307026

§ 371 Date: Oct. 16, 2008

(30) Foreign Application Priority Data
Apr. 4, 2005 (JP) 2005-107060
Mar. 15, 2006 (JP) 2006-071326

(51) Int. Cl. F21V 21/00; F21V 7/00

(52) U.S. Cl. 362/623; 362/217.11

(57) ABSTRACT

A light emitting unit comprises a light emitting element, a light emitting element substrate for mounting the light emitting element, a light emitting element substrate frame member provided with a window for exposing the light emitting element, and an electrode for supplying electricity to the light emitting element, wherein the light emitting element substrate is a metal and the light emitting element is mounted directly on the light emitting element substrate. The light emitting unit is also characterized in that the light emitting element substrate is a metal, a metal oxide film is provided on the light emitting element substrate, and the light emitting element is mounted on the electrode formed on the metal oxide film.

### BACKGROUND OF THE INVENTION

1. Field of the Invention

The present invention relates to a light emitting unit, a light emitting device and a line illumination device used in illumination, an automobile, industrial equipment and general consumer equipment in which this light emitting unit is incorporated, and an image scanner in which this line illumination device is incorporated.

2. Description of the Prior Art

An image sensor is incorporated in an image scanner, for scanning a document, such as a facsimile machine, a copying machine and an image scanner device. The image sensor may be a contact-type or a reduction-type, but each image sensor type is provided with a line illumination device for linearly illuminating a document surface along the main scanning range.

The line illumination device using a light guide is known. For example, Japanese Patent Application Publication No. H08-163320 and Japanese Patent Application Publication No. H10-126581 (Japanese Patent No. 2999431) disclose a line illumination device using a bar-shaped or plate-shaped light guide, and an image scanner using the line illumination device.

The line illumination device is composed of a light guide adapted to cause the light incoming from an end face to be emitted from a light emitting surface provided along the longitudinal direction while causing the light to reflect on the inner surface, and a light emitting unit provided on the end surface side of the light guide. FIG. 14 shows a front view of a conventional light emitting unit and FIG. 15 shows a perspective view of a conventional line illumination device. As described in Japanese Patent Application Publication No. 2003-023525 and Japanese Patent Application Publication No. H11-136449, a light emitting unit 20 has a light emitting element substrate frame member 21 made of resin in which lead frames 22 are disposed. The light emitting element substrate frame member 21 is provided with a window 21a for mounting light emitting elements 23a, 23b and 23c. The lead frame 22 is provided with lead terminal sections 22a, each serving as an external connection terminal, internal lead sections 22c, and light emitting element mounting and connecting sections 22b exposed within the window 21a, wherein the light emitting elements 23a, 23b and 23c adhere to the lead frames 22 exposed within the window 21a, electrodes of the light emitting elements 23a, 23b and 23c are connected to the lead frames 22 by metal wires 24, and the window 21a is then sealed with transparent resin.

### [Patent Document 1] Japanese Patent Application Publication No. 2003-023525

[Patent Document 2] Japanese Patent Application Publication No. H11-136449

In an image scanner, the quality of an image to be scanned can be improved by enhancing the brightness of illumination light of an illumination device. However, to enhance the brightness of the illumination light, the conduction current of a light emitting unit must be increased to increase the amount of light emission.

When a light emitting element is electrically connected, junction temperature rises simultaneously with emission (heat is generated from the light emitting element itself). The generated heat dissipates from the side of a light emitting element substrate to be finally dissipated in the air. Thus, the rise in the junction temperature depends on the dissipation characteristics of the light emitting element substrate and is substantially proportional to the conduction current. In other words, if the dissipation characteristics of the substrate used in the light emitting unit are good, the percentage of rise of the junction temperature becomes smaller.

On the other hand, operation (i.e., electrical connection) of the light emitting element at a high temperature results in causing the light emitting element to deteriorate quickly. Thus, to extend the life of the light emitting element, it is desirable that the temperature rise of the light emitting element be controlled. Thus, the higher the heat dissipation performance of the light emitting element substrate, the larger the maximum current which can be applied to the light emitting unit.

In the light emitting unit of which the heat dissipation performance is insufficient, if the conduction current of the light emitting element is increased to enhance the brightness of the line illumination device, the calorific value of the light emitting element proportionately becomes high and the luminous efficiency decreases. Thus, there is a problem in which it is difficult to enhance the brightness.

Higher quality image scanning performance is required as technology advances. It is therefore required to increase the conduction current of the light emitting element by about 10 times over the conventional level. However, there is a problem in which the current can only be increased by about 2-3 times over the conventional level because the heat dissipation performance is insufficient when a conventional light emitting element is used.

The conventional light emitting element is provided in such a manner that the lead frames 22 are disposed on the light emitting element substrate frame member 21 made of resin and the light emitting elements 23a, 23b and 23c are mounted on the lead frames 22. However, when the resin substrate is used, the conduction current of the light emitting element cannot be increased because the heat dissipation performance is insufficient. As shown in FIG. 16, in place of housing a metal lead frame within the resin frame member, if an electrode is provided on a metal substrate with large heat conductivity and the resin frame member is provided only on the surface of the metal substrate, the heat dissipation performance can be increased. However, in the case where an electrode 27 is disposed on a metal substrate 28, the electrode 27 must be provided on an insulating resist 281. In this case, there is a problem in which sufficient heat dissipation performance cannot be obtained because this insulating resist 281 has low heat conductivity and the heat from the light emitting element 23 cannot be efficiently conducted to the metal substrate 28.

### SUMMARY OF THE INVENTION

It is therefore an object of the present invention to provide an improved light emitting unit for an illumination device and an image scanner which can solve the problems described above and exhibits excellent heat dissipation performance.

To solve the problems described above, a light emitting unit according to the present invention is provided, which comprises a light emitting element, a light emitting element substrate for mounting the light emitting element, a light emitting element substrate frame member provided with a window for exposing the light emitting element, and an electrode for supplying electricity to the light emitting element, wherein the light emitting element substrate is a metal and the light emitting element is mounted directly on the light emitting element substrate. The light emitting unit according to the present invention is also provided, in which the light emitting element substrate is a metal, a metal oxide film is provided on the light emitting element substrate, and the light emitting element is mounted on the electrode formed on the metal oxide film. It is desirable that the metal oxide film be an aluminum oxide film.

A bar-shaped illumination device using the light emitting unit according to the present invention is provided, in which the light incoming from the light emitting unit provided on the end surface side of the bar-shaped light guide in the longitudinal direction is emitted from a light emitting surface provided along the longitudinal direction of the bar-shaped light guide while causing the light to reflect on the inner surface of the bar-shaped light guide. Further, a plate-shaped illumination device using the light emitting unit according to the present invention is provided, in which the light incoming from the light emitting unit provided on the side surface of the plate-shaped light guide in the thickness direction is emitted from the upper or lower surface of the plate-shaped light guide while causing the light to reflect on the inner surface of the plate-shaped light guide.

Still further, an image sensor according to the present invention is provided, in which the illumination device, a line image sensor, and an optical system for converging the reflected light or the transmitted light from a document on the line image sensor are incorporated in a casing. An image scanner in which the image sensor is incorporated is also provided.

### BRIEF DESCRIPTION OF THE DRAWINGS

The above and other objects, features and advantages of the present invention will become more apparent from the following description when taken in conjunction with the accompanying drawings.

FIG. 1 is a cross sectional view of an image scanner in which a line illumination device according to the present invention is incorporated;

FIG. 2 is an exploded perspective view of the line illumination device;

FIG. 3 is a perspective view showing one example of light scattering patterns formed on the reverse side of a light guide;

FIG. 4 is a front perspective view of a light emitting unit of the present invention;

FIG. 5 is a sectional side view of the light emitting unit of the present invention;

FIG. 6 is a partial sectional view of the light emitting unit of the present invention;

FIG. 7 is a partial sectional view of the light emitting unit of the present invention in an altered form;

FIG. 8 is a wiring diagram of a light emitting element within the light emitting unit;

FIG. 9 is a perspective view of an illumination device using the light emitting unit of the present invention;

FIG. 10 is a partially sectional view of an opening window section of the light emitting unit;

FIG. 11 is a cross sectional view showing another embodiment of the image scanner;

FIG. 12 is an exploded perspective view of an illumination device incorporated in FIG. 11;

FIG. 13 is a pattern diagram showing the structure of a reduction-type image sensor;

FIG. 14 is a front view of a conventional light emitting unit;

FIG. 15 is a perspective view of a conventional line illumination device; and

FIG. 16 is a partially sectional view of a conventional light emitting unit.

### DETAILED DESCRIPTION OF THE PREFERRED EMBODIMENTS

Preferred embodiments of the present invention will now be described with reference to the accompanying drawings.

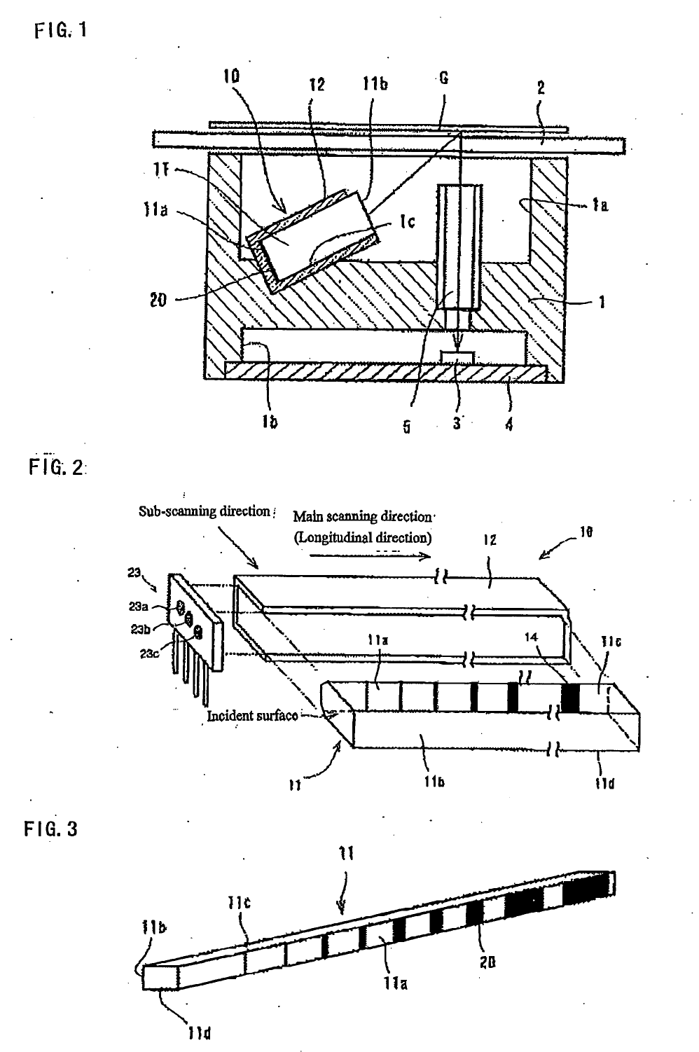

FIG. 1 is a cross sectional view of an image scanner in which a line illumination device is incorporated and FIG. 2 is an exploded perspective view of the line illumination device. FIG. 3 is a perspective view showing one example of light scattering patterns formed on the reverse face of a light guide.

As shown in FIG. 1, an image scanner comprises an image sensor, a glass plate, and a casing adapted to house the image sensor and the glass plate therein. Referring to the image sensor, a frame 1 of the image sensor is provided with depressions 1a, 1b and 1c, wherein a line illumination device 10 is disposed in the depression 1c and a sensor substrate 4 provided with a photoelectric conversion element (i.e., a line image sensor) 3 is installed in the depression 1b. A rod lens array 5 for 1:1 imaging is retained within the frame 1. A glass plate 2 is provided above the frame 1. The light emitted from a light emitting surface 11b of the line illumination device 10 is applied to a document G through the glass plate 2. The reflected light from the document G is detected by the photoelectric conversion element (i.e., the line images sensor) 3 through the lens array 5 of an erecting 1:1 imaging system (an erecting unit magnification imaging system) to scan the document G. The rod lens array, a flat plate type micro lens array and the like can be used as the erecting 1:1 imaging system. A desired area of the document G is scanned by moving the frame 1 of the image sensor in the sub-scanning direction of FIG. 2 relative to the glass plate 2.

A method for mounting the light emitting unit 20 on a transparent light guide 11 will now be described below. The transparent light guide 11 and the light emitting unit 20 are provided with a corresponding depression or projection, wherein the projection is fitted into the depression. The transparent light guide 11 and the light emitting unit 20 can be brought into contact or can be spaced apart by a fixed distance to provide a gap therebetween. The amount of light introduced to the light guide can be adjusted by the distance of the spacing.

As shown in FIG. 2, the line illumination device 10 is provided in such a manner that the light guide 11 is installed in a white light guide casing 12 to expose the light emitting surface 11b, and a light emitting unit provided with one or more light emitting elements (e.g., light emitting diodes) 23 as a light source is attached to one end of the light guide casing 12. The light guide 11 is composed of a translucent material such as glass and acrylic. The basic cross sectional shape of the light guide 11 in the direction perpendicular to the main scanning direction (i.e., the longitudinal direction) is made rectangular, wherein an angulation (corner) section between a surface 11a where scattering patterns are provided and a side surface 11b and an angulation section between the surface 11a and a surface 11c are chamfered in a C-shape.

As shown in FIG. 3, light scattering patterns 20 for scattering the light from a light source incoming from the incident surface are formed on the reverse sides of the light guide 11 by screen printing of white paints, formation of a projection and a depression, and the like. The line illumination device 10 introduces the light from the light source into the light guide 11 from one end (incidence surface) of the light guide 11, scatters the light propagating within the light guide 11 by the light scattering patterns formed on the reverse side of the light guide 11, and emits the scattered light from the light emitting surface 11b.

The intensity of light incoming from the light source is large on the side near the light incidence surface and becomes smaller as the distance from the incident surface increases. As shown in FIG. 3, the light emitting from the light emitting surface 11b is made uniform over the whole length of the main scanning direction by broadening a formation area of the scattering patterns as the distance from the incidence surface increases.

As shown in FIGS. 1 and 2, the light guide 11 is covered by the light guide casing 12 for protection. With this arrangement, it is possible to prevent the scattered light from being uselessly emitted outside the light guide and to increase the intensity of the outgoing light.

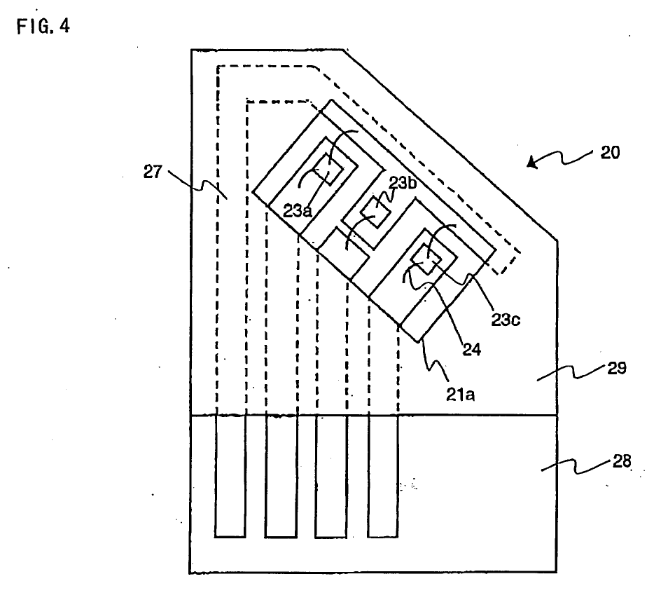

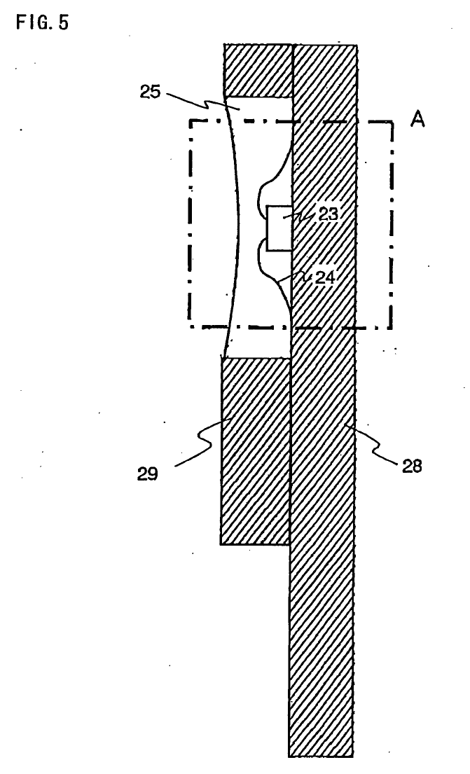

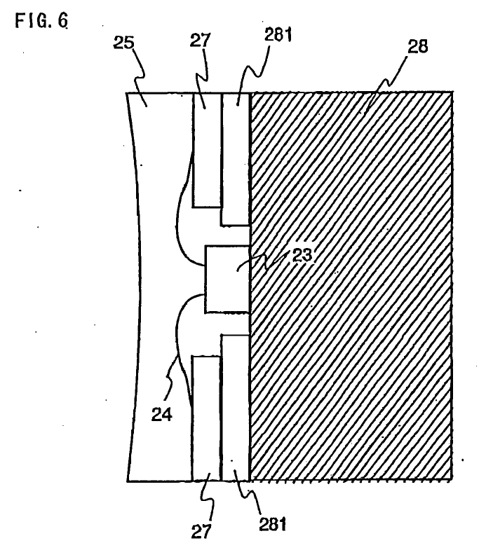

FIG. 4 is a front perspective view of a light emitting unit and FIG. 5 is a sectional side view of the light emitting unit. The light emitting unit 20 is provided in such a manner that an electrode 27 is provided on a metal substrate 28 and light emitting elements 23 (23a, 23b and 23c) are mounted on the electrode 27. Electricity is supplied to the light emitting elements 23 through the electrode 27. The light emitting element 23a emits a blue color, the light emitting element 23b emits a red color, and the light emitting element 23c emits a green color. A metal substrate 28 is covered by a frame member 29 provided with an opening window 21a for exposing the light emitting elements 23. It is desirable that the material of the frame member 29 be white resin to easily reflect the light. The inside of the window 21a is sealed with a transparent resin 25. The metal substrate 28 can be selected from aluminum, copper, silver, gold, stainless steel and the like which preferably have a high degree of heat conductivity.

FIG. 6 is a partially enlarged cross sectional view of an area A of FIG. 5. The light emitting element 23 is mounted directly on the metal substrate 28, and an insulating resist film 281 and the electrode 27 are provided on a section of the metal substrate 28 other than the light emitting element 23. The light emitting element 23 is caused to adhere to the metal substrate 28 using a conductive paste, a resin adhesive or the like. The light emitting element 23 is electrically connected to the electrode 27 by a metal wire 24. In the case where electricity needs to be supplied even from the reverse side of the light emitting element 23, the light emitting element 23 is caused to adhere to the metal substrate 24 using the conductive paste. However, in the case where electricity is sufficient with supply only from the metal wire 24, it is desirable that the light emitting element 23 be made to adhere to the metal substrate 28 using a transparent adhesive because use of the transparent adhesive facilitates the reflection of light and makes the effective utilization of the outgoing light possible. In the present embodiment, the conductive paste is used for the red color light emitting element 23b, while the transparent resin adhesive is used for the blue and green color light emitting elements 23a and 23c.

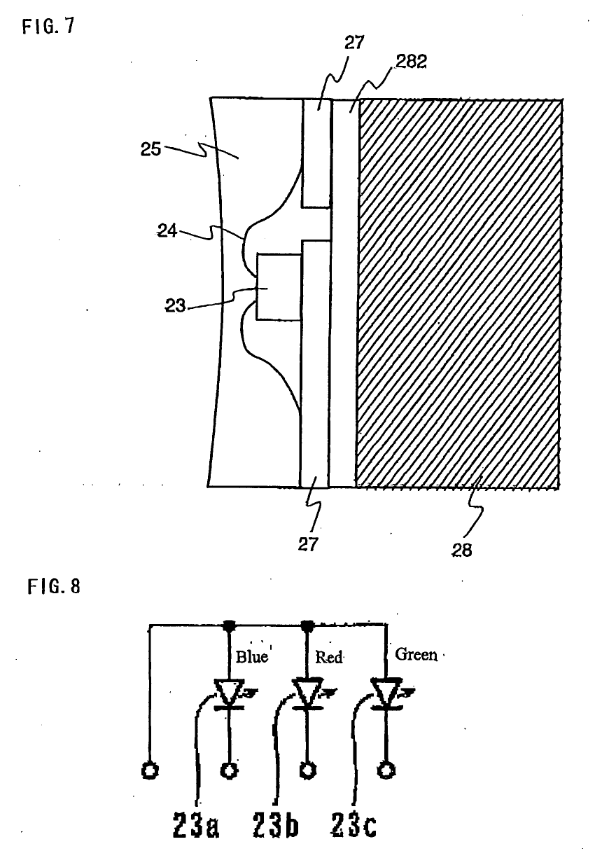

FIG. 7 is a partially enlarged cross sectional view of a light emitting unit showing another embodiment of the present invention.

A metal oxide film layer 282, an electrode 27, and a light emitting element 23 are provided on the metal substrate 28 in that order. The light emitting element 23 is electrically connected to the electrode 27 by a metal wire 24. The metal oxide film layer 282 functions as an insulating layer. It is desirable that a metal oxide film layer with a high degree of heat conductivity be used. In the case where aluminum is used as the metal substrate, the surface of the aluminum is anodized in white to obtain the metal oxide film. The reason why the aluminum has been processed in white is because light from the light emitting element 23 can be reflected to improve the emission efficiency.

FIG. 8 is a wiring diagram of the light emitting element within the light emitting unit. FIG. 8 shows an example of a line illumination device for color scanning. The color, number, and wire connections of the light emitting elements 23 to be mounted within the light emitting unit 20 can be combined in various ways according to the purpose of scanning. When electricity is supplied to the light emitting unit 20, the light emitting element 23 emits light. The emission brightness (luminescence intensity) also becomes large by increasing the conduction current.

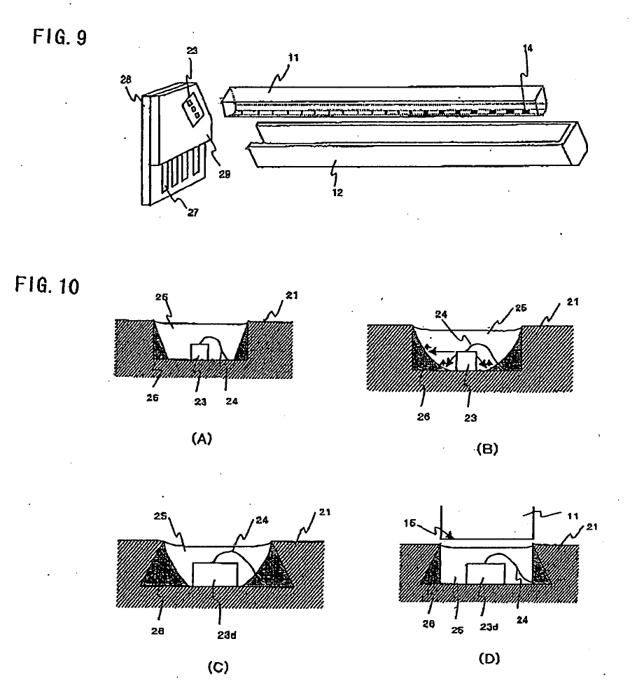

FIG. 9 is a perspective view showing an illumination device in which a light emitting unit mounting a large light emitting element is incorporated. When the large light emitting unit is employed, as shown in FIG. 10(D), the area of the upper section of a window in a light emitting element substrate frame member becomes larger than that of an incident end surface of a bar-shaped light guide. It is therefore desirable that the opening area be adjusted by filling a colored resin 26 of a high color value into the opening window, as shown in FIGS. 10(A), (B) and (C).

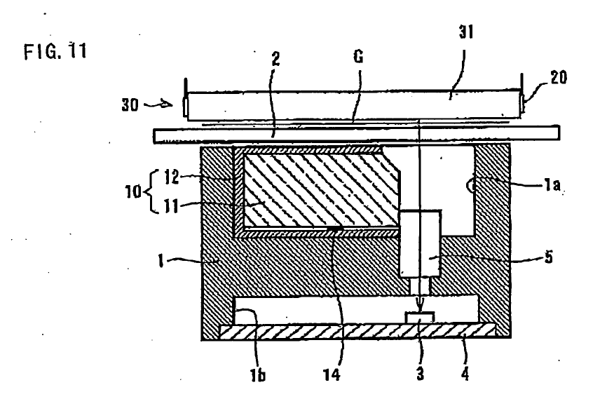

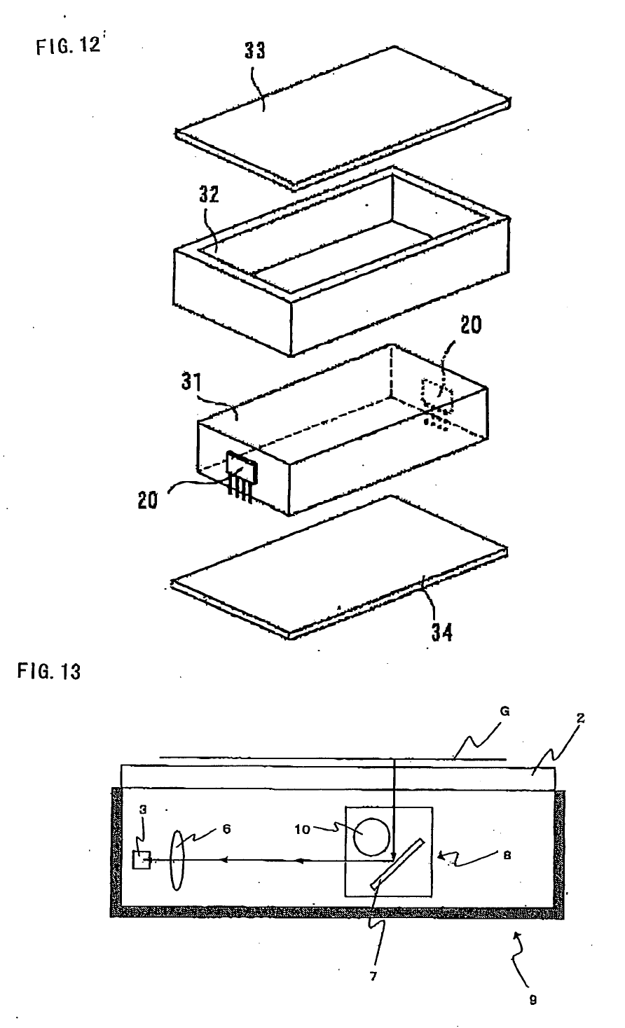

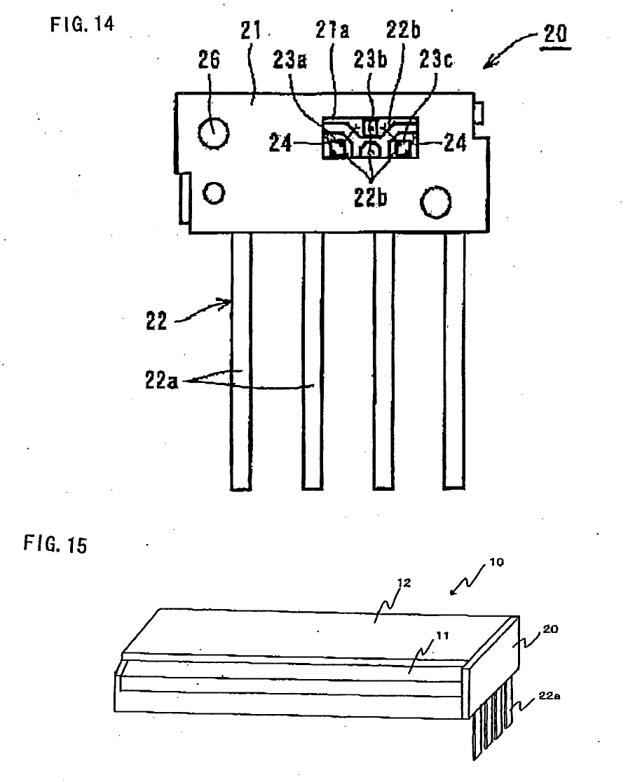

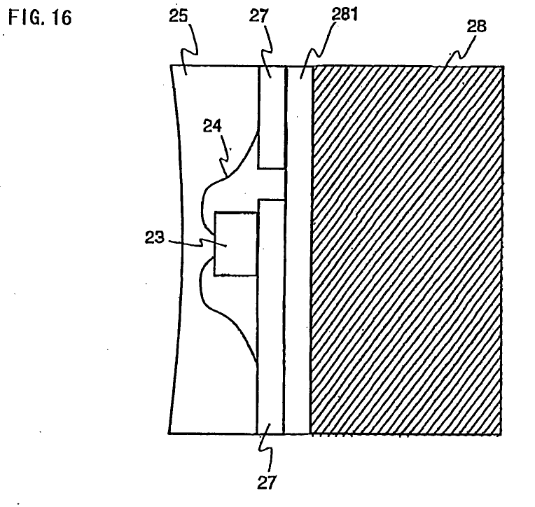

FIG. 11 is a cross sectional view showing another embodiment of an image scanner and FIG. 12 is an exploded perspective view of an illumination device which is incorporated in FIG. 11. In the image scanner as shown in FIG. 11, the reflected light from a document G is detected by a photoelectric conversion element (i.e., a line image sensor) 3 through a rod lens array 5 to scan the document G. In this embodiment, in addition to the functions described above, an illumination device 30 can also be disposed on an OHP document G and the like to scan the transmitted light of the document G using the photoelectric conversion element 3. These embodiments are also provided, in the same manner as in the image scanner of FIG. 1, to move a frame 1 relative to a glass plate 2 to scan a desired area of the document G.

The illumination device 30 is provided in such a manner that the light emitting unit 20 is attached in the thickness direction to the side surface of a plate-shape light guide 31 made of transparent acrylic resin, the plate-shaped light guide 31 is housed within a white casing 32 (not shown), the upper surface serving as the reflection surface is provided with a white light reflector 33 (not shown), and the lower surface serving as the light emitting surface is provided with a diffusion sheet 34 (not shown).

The above description refers to the embodiments in a contact-type image sensor, but the illumination device according to the present invention can also be applied to a reduction-type image sensor. In an image scanner 9, as shown in FIG. 13, in which a reduction-type image sensor 8 is employed, a document placed on a transparent document table, such as a glass, is illuminated by an illumination device 10, the light reflected from the document surface is caused to reflect by a mirror 7 to be converged by a lens 6, so that the light is detected by a photoelectric conversion element 3. In the reduction-type image sensor, there is a case where the term “image sensor section” refers only to the photoelectric conversion element 3. However, the image sensor in the present specification is a section composed of an illumination device, a mirror, a photoelectric conversion element and a lens in the reduction-type image sensor.

### Effects of the Invention

According to the present invention, a light emitting element can be mounted directly on a substrate. In this manner, heat generated from a junction of the light emitting element can be efficiently dissipated onto the substrate and high current can be conducted. According to the present invention, heat dissipation efficiency is better than a conventional resin resist film and higher current can be conducted because a metal oxide film is provided on a metal substrate as an insulating film.

In the case where a large light emitting unit made of a resin substrate is used, it is not possible to increase the electric current because heat dissipation performance is insufficient. In this manner, even if the light emitting unit is made larger, only the current of the same level as a small unit can be conducted. However, according to the present invention, an illumination device with high illumination intensity can be provided using a large light emitting unit because heat dissipation performance of the substrate used in the light emitting unit can be upgraded.

1. A light emitting unit comprising:
a light emitting element;
a light emitting element substrate for mounting the light emitting element;
a light emitting element substrate frame member provided with a window for exposing the light emitting element; and
an electrode for supplying electricity to the light emitting element;
wherein the light emitting element substrate is a metal and the light emitting element is mounted directly on the light emitting element substrate.

2. A light emitting unit comprising:
a light emitting element;
a light emitting element substrate for mounting the light emitting element;
a light emitting element substrate frame member provided with a window for exposing the light emitting element; and
an electrode for supplying electricity to the light emitting element;
wherein the light emitting element substrate is a metal, a metal oxide film is provided on the light emitting element substrate, and the light emitting element is mounted on the electrode formed on the metal oxide film.

3. The light emitting unit according to claim 2, wherein the metal oxide film is an aluminum oxide film.

4. An illumination device comprising light emitting unit of claim 1 provided on the side of an end surface of a bar-shaped light guide in the longitudinal direction, wherein light incoming from the light emitting unit is emitted from a light emitting surface provided along the longitudinal direction of the bar-shaped light guide while the incoming light is reflected onto the inner surface of the light guide.

5. An illumination device comprising light emitting unit of claim 1 provided on the side surface of a plate-shaped light guide in the thickness direction, wherein light incoming from the light emitting unit is emitted from an upper surface or a lower surface of the plate-shaped light guide while the incoming light is reflected onto the inner surface of the light guide.

6. An image sensor comprising: a casing together with the illumination device according to claim 4, a line image sensor, and an optical system for converging the reflected light or the transmitted light from a document onto the line image sensor incorporated in the casing.

7. An image scanner comprising the image sensor according to claim 6.

8. An image scanner comprising:
an image sensor;
a transparent body for mounting a document; and
an illumination device according to claim 4 provided above the transparent body.
